(19) United States
(12) Patent Application Publication
(10) Pub. No.: US 2004/0236978 A1
(43) Pub. Date: Nov. 25, 2004

(54) Subsystem for setting clock signal to have different frequency for data bus from that for command/address bus

(75) Inventor: Ha Ryong Yoon, Gyeonggi-do (KR)

Correspondence Address: HELLER EHRMAN WHITE & MCAULIFFE LLP, 1666 K STREET,NW, SUITE 300, WASHINGTON, DC, 20006, US

(73) Assignee: Hynix Semiconductor Inc., Gyeonggi-do (KR)

(21) Appl. No.: 10/734,225

(22) Filed: Dec. 15, 2003

(30) Foreign Application Priority Data
May 24, 2003 (KR) 10-2003-0033156

(51) Int. Cl. G06F 1/04

(52) U.S. Cl. 713/500

(57) ABSTRACT

A subsystem comprises a master and a plurality of slaves. The master comprises a clock generator for generating a first clock signal and a second clock signal which have different frequency each other. When command and address signals are received from the master, the plurality of slaves transmits the corresponding data signals to the master. Here, the first clock signal is used to require command and address signals to the corresponding slave, and the second clock signal is used to transmit data signals into the corresponding slave, thereby preserving the improved signal integrity to a command and address buses and simplifying circuit blocks, communication methods and system configuration.

### BACKGROUND OF THE INVENTION

1. Field of the Invention

The present invention generally relates to a subsystem comprising a master and a plurality of slaves, and more specifically, to a memory subsystem which may simplify circuit related to command and address signal by setting a clock frequency for the command and address buses different from that for a data bus.

2. Description of the Prior Art

FIG. 1 is a block diagram of a conventional memory subsystem.

The conventional memory subsystem comprises a memory controller (master) 1 and a plurality of memory devices (slaves) 2. Although memory device 2 is exemplified for the slave herein, a receiver or an arithmetic logic unit (ALU) may be used instead.

The memory controller 1 transmits command and address signals into the plurality of memory devices 2 through a command bus 3 or an address bus 4, respectively. The memory controller 1 activates the corresponding memory device 2 in response to a chip selection signal CS.

The memory controller 1 stores input data in the corresponding memory device 2 through a data bus 5, and outputs the data stored in the memory device 2.

All the operations of memory devices 2 are performed synchronously with respect to clock signals CLK and CLKb which are transmitted from the memory controller 1 through a clock bus 6.

FIGS. 2a and 2b are timing diagrams of the memory subsystem of FIG. 1. Here, the frequency of the clock signal CLK is 400 MHz, and command/address is sampled only at a rising edge of the clock signal CLK.

FIG. 2a shows when the subsystem performs write WR, write WR, read RD, write WR and write WR commands sequentially while FIG. 2b shows when the subsystem performs read RD, read RD, write WR, read RD and read RD commands sequentially.

In order to sample command, address and data signals in a high frequency system, a phase locked loop (PLL) or delay locked loop (DLL) is required.

As a result, timing window (setup time and holding time) for sampling is narrowed, thereby degrading the signal integrity. In order to solve the problem, additional circuit blocks and system boards are required, which results in difficulty of the design.

### SUMMARY OF THE INVENTION

Accordingly, it is an object of the present invention to provide a subsystem for setting clock frequencies for a command and address buses different from that for a data bus, thereby simplifying the configuration of command and address circuits and securing command and address setup and holding time to perform the stabilized operation.

A subsystem comprises a master and a plurality of slaves. The master comprises a clock generator for generating a first clock signal and a second clock signal which have different frequencies each other. The plurality of slaves receives command and address signals from the master and transmits the corresponding data signals to the master. Here, the first clock signal is used to receive command and address signals to the corresponding slave, and the second clock signal is used to transmit data signals into the corresponding slave.

### BRIEF DESCRIPTION OF THE DRAWINGS

FIG. 1 is a block diagram of a conventional memory subsystem.

FIGS. 2a and 2b are timing diagrams of the memory subsystem of FIG. 1.

FIG. 3 is a block diagram of a memory subsystem according to an embodiment of the present invention.

FIG. 4 is a detailed block diagram of a clock synchronization circuit of a memory controller of FIG. 3.

FIGS. 5a and 5b are timing diagrams of the memory subsystem of FIG. 3.

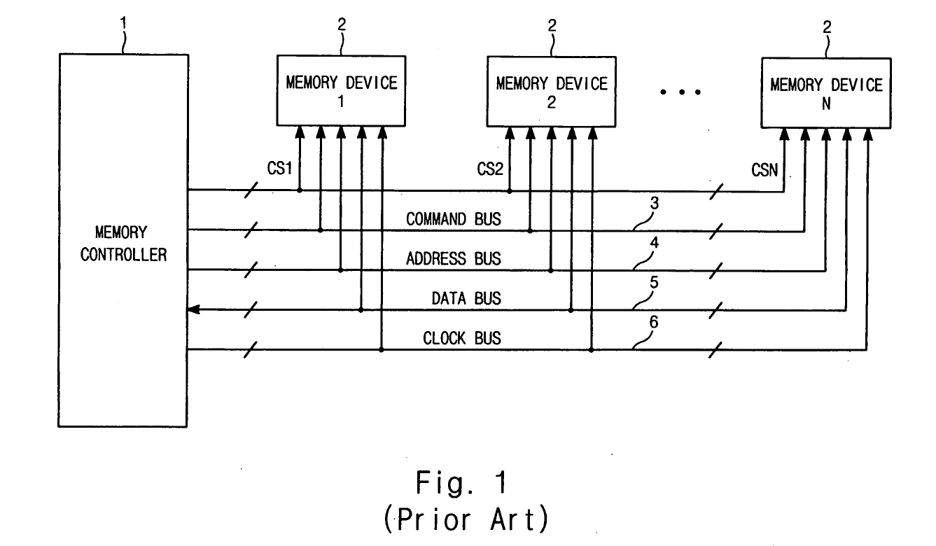

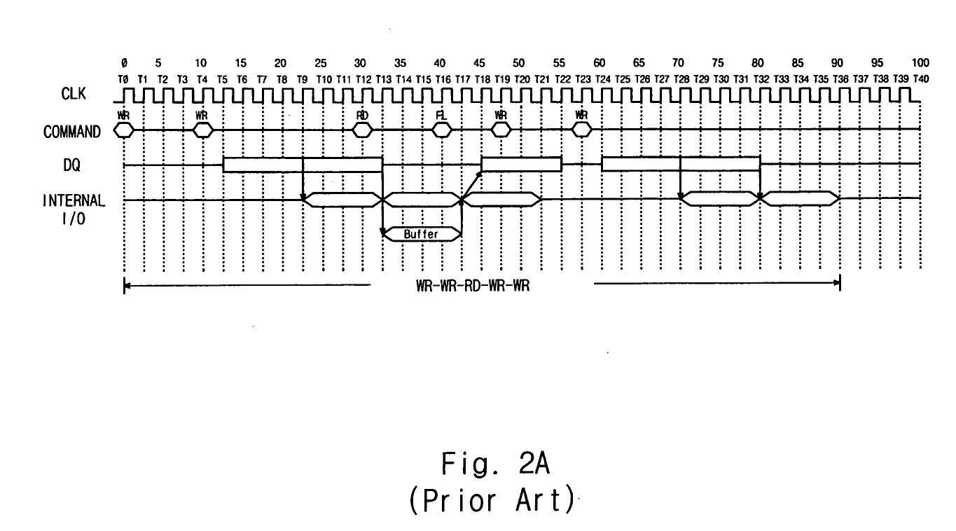

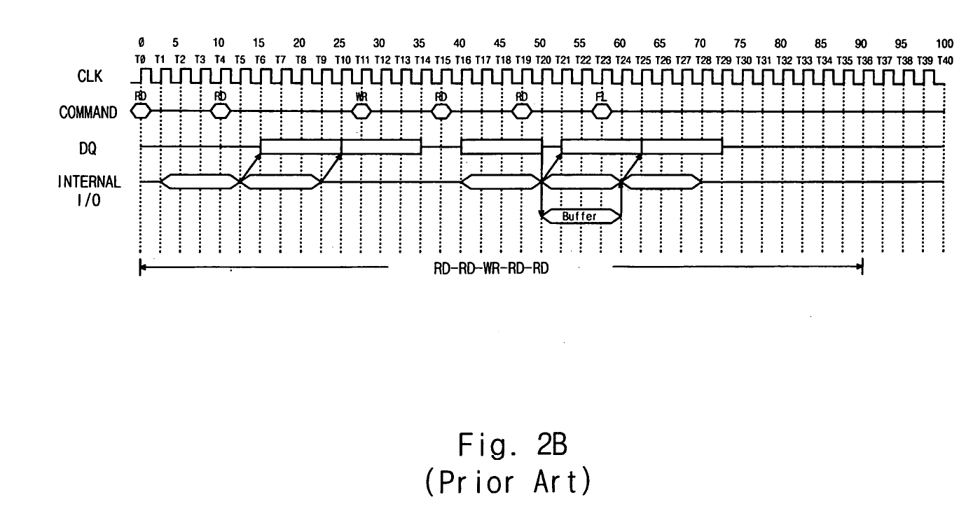

### DETAILED DESCRIPTION OF THE PREFERRED EMBODIMENTS

The present invention will be described in detail with reference to the accompanying drawings.

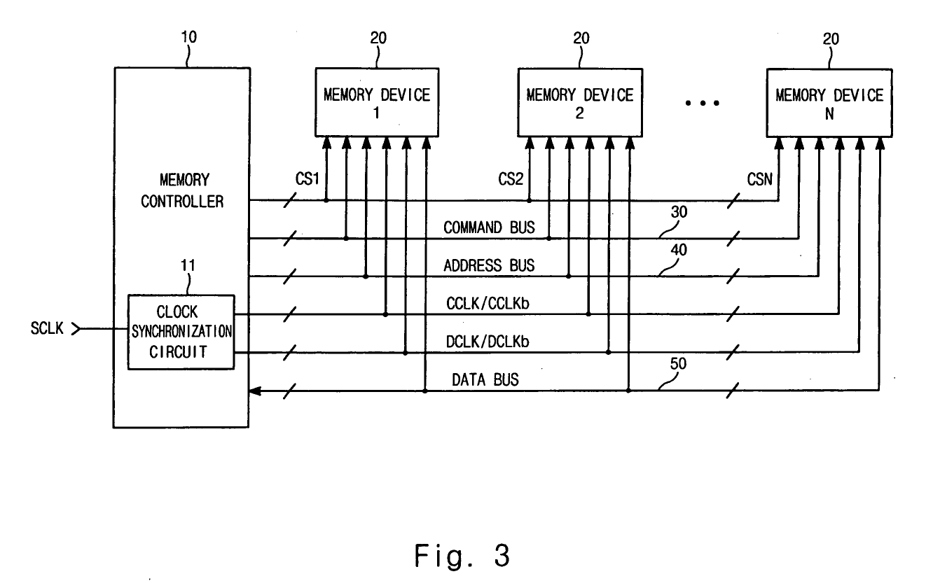

FIG. 3 is a block diagram of a memory subsystem according to an embodiment of the present invention.

In an embodiment, the memory subsystem comprises a memory controller (master) 10 and a plurality of memory devices (slaves) 20.

Although a memory device 2 is exemplified for the slave herein, a receiver or an arithmetic logic unit (ALU) may be used instead.

The memory controller 10 transmits command and address signal into the plurality of memory devices 20 through a command bus 30 or address bus 40, respectively. Here, the memory controller 10 activates the corresponding memory device 20 in response to a chip selection signal CS.

The memory controller 10 stores input data in the corresponding device 20 through a data bus 50, and externally outputs the data stored in the memory device 20.

The operations related to the command and address-signals are performed synchronously with respect to a pair of clock signals CCLK and CCLKb having low frequency, and the data-related operations are performed synchronously with respect to a pair of clock signals DCLK and DCLKb having high frequency.

The memory controller 10 comprises a clock synchronization circuit 11 for generating the clock signals CCLK and CCLKb having low frequency to control the operations related to command and address signals, and the clock signals DCLK and DCLKb having high frequency to control the data-related operations.

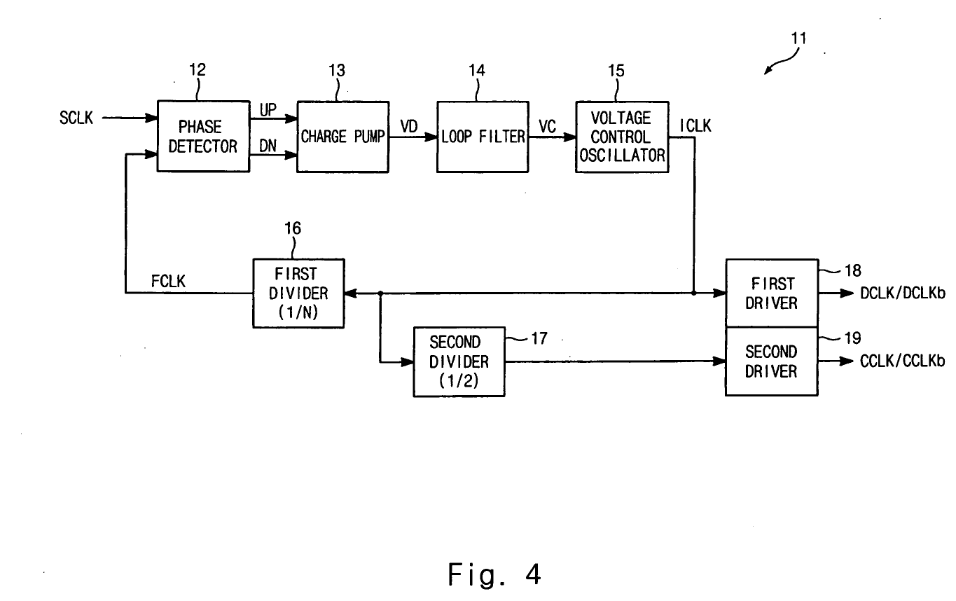

FIG. 4 is a detailed block diagram of the clock synchronization circuit 11 of FIG. 3. For the clock synchronization circuit 11, a phase locked loop (PLL) or delay locked loop (DLL) circuit is used. Here, the PLL is exemplified.

The clock synchronization circuit 11 comprises a phase detector 12, a charge pump 13, a RC loop filter 14, a voltage control oscillator (VCO) 15, dividers 16 and 17, and drivers 18 and 19.

The phase detector 12 compares a phase of a system clock signal SCLK with that of a feedback clock signal FCLK outputted from a 1/N divider 16, and outputs control signals UP and DN in response to the comparison result.

The charge pump 13 outputs a predetermined voltage VD in response to the control signals UP and DN.

The loop filter 14 comprises a low pass filter for filtering the voltage VD outputted from the charge pump 13 to remove high frequency and outputting a DC control voltage VC.

The VCO 15 outputs a clock signal ICLK having a frequency proportional to the control voltage VC outputted from the loop filter 14.

The first divider 16 divides the cycle of the clock signal ICLK outputted from the VCO 15 in a predetermined division ratio (1/N) to reduce the synchronization time.

The second divider 17 divides the clock signal ICLK in a predetermined ratio (1/M) in order to synchronize the operations related to the command and address signals to a clock signal having lower frequency than that of the data-related operations. Here, the division ratio is 1/2.

The first driver 18 drives the clock signal ICLK outputted from the VCO 15, and outputs clock signals DCLK and DCLKb.

The second driver 19 drives a clock signal outputted from the second divider 17, and outputs clock signals CCLK and CCLKb whereto the operations related to the command and address signals are synchronized.

The clock synchronization device 11 synchronizes the internal clock signals DCLK and CCLK to a system clock signal SCLK. A clock signal wherein the frequency of the clock signal DCLK is divided in 1/2 by the second divider 17 is used as the clock signal CCLK whereto the command/address-related operations are synchronized.

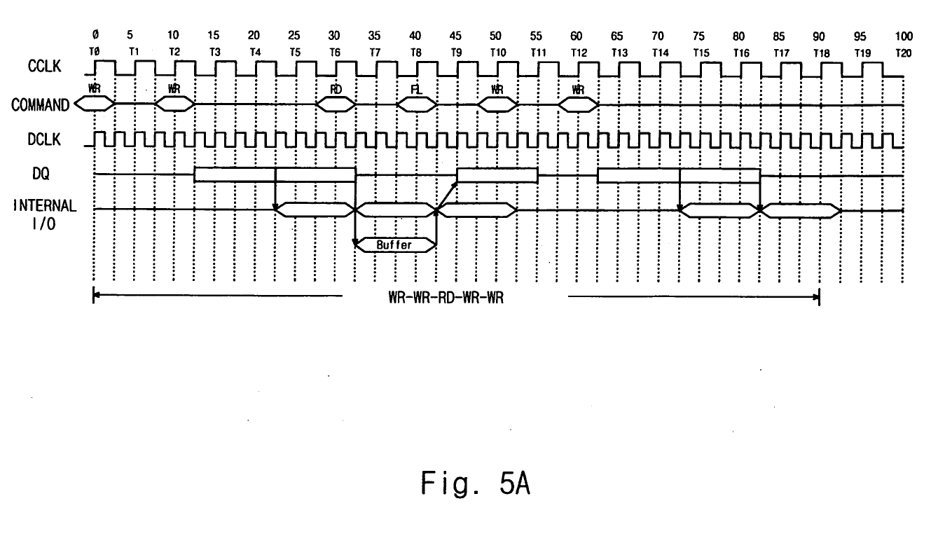

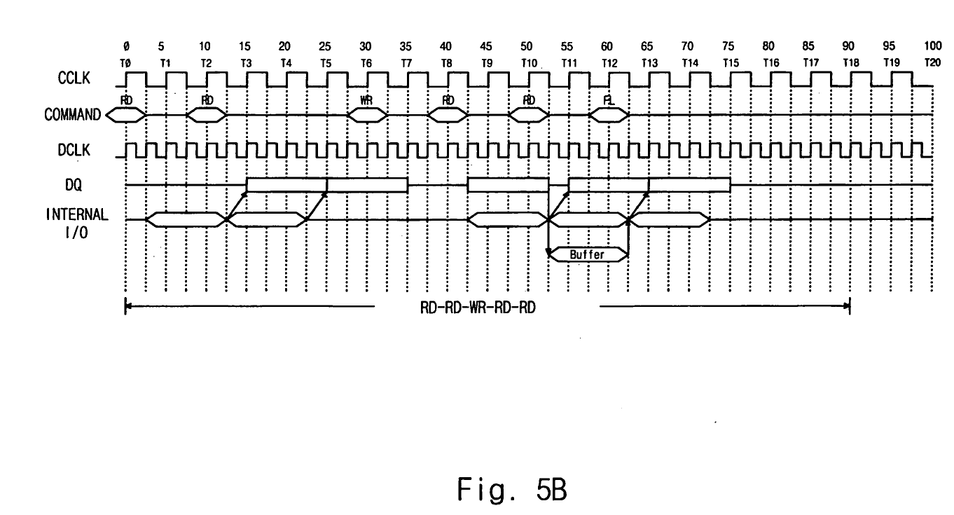

FIGS. 5a and 5b are timing diagrams of the memory subsystem of FIG. 3. Here, the clock signal CCLK to the command/address bus has a frequency of 200 MHz, and the clock signal DCLK to the data bus has a frequency of 400 MHz. The command/address are sampled only at a rising edge of the clock signal CLK.

FIG. 5a shows when the subsystem performs write WR, write WR, read RD, write WR and write WR commands sequentially while FIG. 5b shows when the subsystem performs read RD, read RD, write WR, read RD and read RD commands sequentially.

As the frequencies of the used clock signals becomes lower, the timing window of signals transmitted by command/address buses becomes wider, thereby securing broad margin.

As a result, the semiconductor device can be stably operated without circuits such as PLL, DLL and DCC (duty cycle corrector) to reduce skew of the clock signal CLK. In other words, the signal integrity can be preserved, and circuits may be simplified.

As discussed earlier, in a subsystem according to an embodiment of the present invention, clock signals are set up to have a different frequency for a command/address bus from that for a data bus, thereby preserving the improved signal integrity to command/address buses and simplifying circuit blocks communication methods and system configuration related to the command and address buses.

What is claimed is:

1. A subsystem comprising:
a master comprising a clock generator for generating a first clock signal and a second clock signal which have different frequencies from each other; and
a plurality of slaves for receiving command and address signals from the master and transmitting data signals to the master,
wherein the first clock signal is used for the command and address signals, and the second clock signal is used for the data signals

2. The subsystem according to claim 1, wherein the master transmits command and address signals into the corresponding slave only at a rising edge of the first clock signal.

3. The subsystem according to claim 1, wherein the master transmits command and address signals into the corresponding slave only at a falling edge of the first clock signal.

4. The subsystem according to claim 1, wherein the master transmits command and address signals into the corresponding slave at the rising and falling edges of the first clock signal.

5. The subsystem according to claim 1, wherein the slave is one of a memory module, a receiver and an arithmetic logic unit (ALU).

6. The subsystem according to claim 1, wherein the frequency of the first clock signal is lower than that of the second clock signal.

7. The subsystem according to claim 1, wherein the clock generator is a clock synchronization means.

8. The subsystem according to claim 7, wherein the clock generator further comprises a divider for dividing the first clock signal to generate the second clock signal.

9. The subsystem according to claim 8, wherein the clock generator further comprises:
a first driver for driving the first clock signal; and
a second driver for driving the second clock signal.

10. The subsystem according to claim 7, wherein the clock synchronization means is a phase locked loop circuit.
